(19) United States
(12) Patent Application Publication
(10) Pub. No.: US 2024/0075598 A1
(43) Pub. Date: Mar. 7, 2024

(54) DISPENSED SCREW POSITIONING UNIT FOR A DELIVERY MECHANISM OF A SCREW GUN

(71) Applicant: WEN-TA TU, TAINAN CITY (TW)

(72) Inventor: WEN-TA TU, TAINAN CITY (TW)

(21) Appl. No.: 17/930,336

(22) Filed: Sep. 7, 2022

(51) Int. Cl. B25B 23/06; B23P 19/06

(52) U.S. Cl. CPC B25B 23/065; B23P 19/06

(57) ABSTRACT

A dispensed screw positioning unit includes a base connected to a delivery mechanism of a screw gun and spaced from the delivery mechanism along a horizontal axis. The base includes two screw dispensing gates configured to clamp a dispensed screw along a vertical axis perpendicular to the horizontal axis. A gap between the two screw dispensing gates in a clamping state is aligned with a screw dispensing hole of the delivery mechanism. The two screw dispensing gates are biased by a first elastic device to the clamping state. A screw dispensed along the horizontal axis overcomes elasticity of the first elastic device to stretch open the two screw dispensing gates. A second elastic device is disposed between the base and the delivery mechanism to form an elastic spacing between the base and the delivery mechanism.

### BACKGROUND OF THE INVENTION

The present invention relates to an accessory for a tool and, more particularly, to a dispensed screw positioning unit for a delivery mechanism of a screw gun.

A power-driven screw gun is popular in the market due to rapid and convenient use in industry manufacturing or household renovation. A delivery mechanism can be attached to a screw gun to continuously dispense screws in a row, permitting massive and consistent operation.

Regarding dispensing of screws, the delivery mechanism generally includes a dispensed screw positioning unit to assure accurate dispensing of screws. A conventional dispensed screw positioning unit mainly includes a base connected to the delivery mechanism. The base includes two screw dispensing gates for clamping a dispensed screw. A gap between the two screw dispensing gates in a clamping state is aligned with a screw dispensing hole of the delivery mechanism. The two screw dispensing gates are biased by an elastic device to the clamping state. A dispensed screw overcomes elasticity of the elastic device to stretch open the two screw dispensing gates. However, the coupling between the base and the delivery mechanism renders a fixed spacing therebetween. When it is desired to change the row of screws to dispense screws of a different size, the spacing between the baes and the delivery mechanism may be too tight or too loose, adversely affecting the screw dispensing accuracy.

### BRIEF SUMMARY OF THE INVENTION

In view of the drawback of the prior art, an objective of the present invention is to provide a dispensed screw positioning unit for a delivery mechanism of a screw gun. The dispensed screw positioning unit includes a base connected to the delivery mechanism and spaced from the delivery mechanism along a horizontal axis. The base includes two screw dispensing gates configured to clamp a dispensed screw along a vertical axis perpendicular to the horizontal axis. A gap between the two screw dispensing gates in a clamping state is aligned with a screw dispensing hole of the delivery mechanism. The two screw dispensing gates are biased by a first elastic device to the clamping state. A screw dispensed along the horizontal axis overcomes elasticity of the first elastic device to stretch open the two screw dispensing gates. A second elastic device is disposed between the base and the delivery mechanism to form an elastic spacing between the base and the delivery mechanism. When screws are dispensed, the elastic spacing permits the base to elastically press against screws of various sizes, providing wider application.

In an example, the second elastic device includes a threaded tube extending along the horizontal axis, a screw rod extending through the base and in threading connection with the threaded tube, and a spring mounted around the screw rod and disposed between the base and the delivery mechanism.

In an example, the screw rod includes an outer end having a chamfered section configured to be clamped by a wrench.

The present invention will become clearer in light of the following detailed description of illustrative embodiments of this invention described in connection with the drawings.

### DESCRIPTION OF THE DRAWINGS

FIG. 1 is a perspective view of a screw gun including an elastic device of an embodiment according to the present invention.

FIG. 2 is a partly-exploded perspective view of the screw gun of FIG. 1, illustrating the elastic device according to the present invention.

FIG. 3 is a diagrammatic top view of the screw gun of FIG. 1.

FIG. 4 is another diagrammatic top view of the screw gun of FIG. 1.

FIG. 5 is another perspective view of the screw gun of FIG. 1.

### DETAILED DESCRIPTION OF THE INVENTION

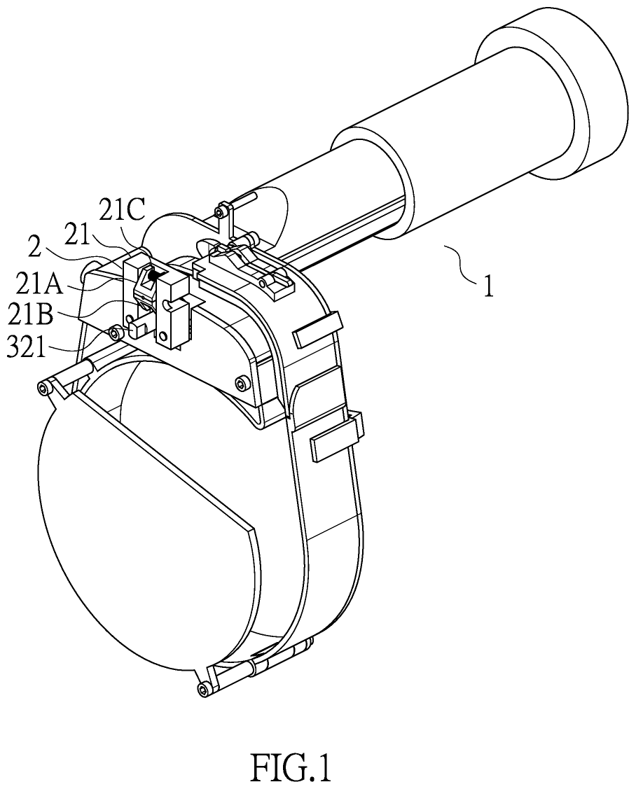

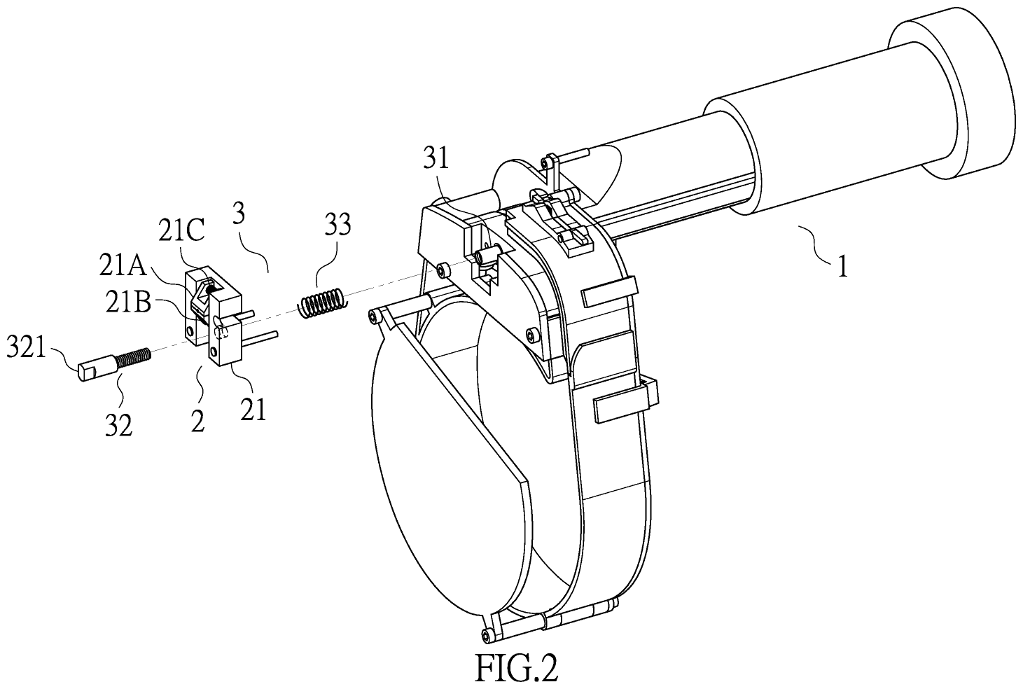

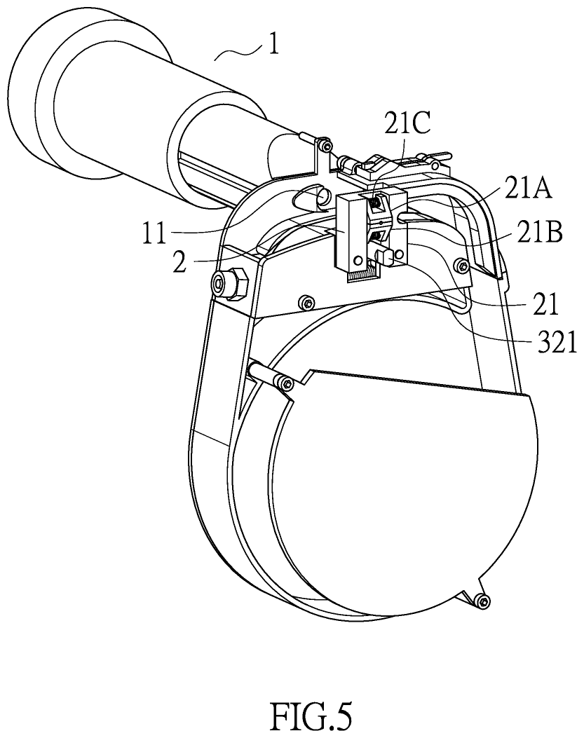

With reference to FIGS. 1-5, the present invention relates to a dispensed screw positioning unit 2 for a delivery mechanism 1 of a screw gun. The dispensed screw positioning unit 2 includes a base 21 connected to the delivery mechanism 1 and spaced from the delivery mechanism 1 along a horizontal axis. The base 21 includes two screw dispensing gates 21A and 21B configured to clamp a dispensed screw along a vertical axis perpendicular to the horizontal axis. A gap between the two screw dispensing gates 21A and 21B in a clamping state is aligned with a screw dispensing hole 11 of the delivery mechanism 1, as shown in FIG. 5. The two screw dispensing gates 21A and 21B are biased by a first elastic device 21C to the clamping state. A screw dispensed along the horizontal axis overcomes elasticity of the first elastic device 21C to stretch open the two screw dispensing gates 21A and 21B. The delivery mechanism 1 can, but not limited to, be of a conventional design, and the detailed structure, principle, and functions thereof are not described to avoid redundancy.

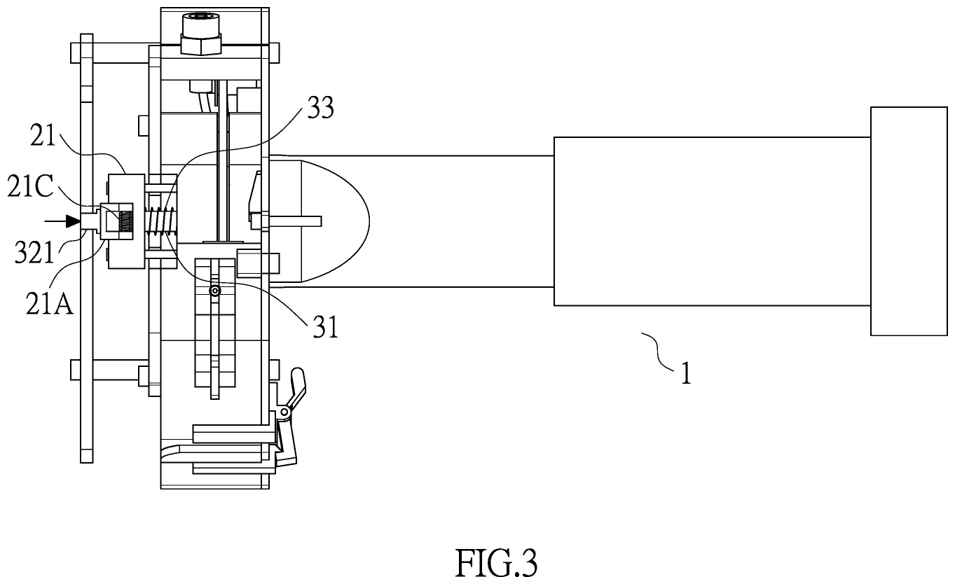

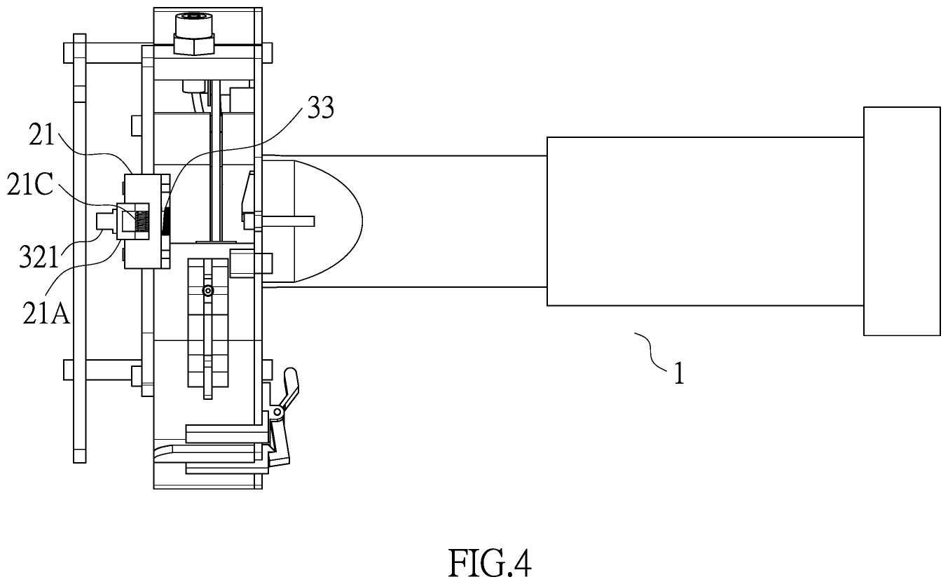

With reference to FIGS. 3 and 4, of more importance, a second elastic device 3 is disposed between the base 21 and the delivery mechanism 1 to form an elastic spacing between the base 21 and the delivery mechanism 1. When screws are dispensed, the elastic spacing permits the base 1 to elastically press against screws of various sizes, providing wider application.

In a preferred embodiment according to the present invention, the second elastic device 3 includes a threaded tube 31 extending along the horizontal axis, a screw rod 32 extending through the base 21 and in threading connection with the threaded tube 31, and a spring 33 mounted around the screw rod 32 and disposed between the base 21 and the delivery mechanism 1. The screw rod 32 includes an outer end having a chamfered section 321 configured to be clamped by a wrench.

Although specific embodiments have been illustrated and described, numerous modifications and variations are still possible without departing from the scope of the invention. The scope of the invention is limited by the accompanying claims.

1. A dispensed screw positioning unit for a delivery mechanism of a screw gun, wherein the dispensed screw positioning unit includes a base connected to the delivery mechanism and spaced from the delivery mechanism along a horizontal axis, wherein the base includes two screw dispensing gates configured to clamp a dispensed screw along a vertical axis perpendicular to the horizontal axis, wherein a gap between the two screw dispensing gates in a clamping state is aligned with a screw dispensing hole of the delivery mechanism, wherein the two screw dispensing gates are biased by a first elastic device to the clamping state, wherein a screw dispensed along the horizontal axis overcomes elasticity of the first elastic device to stretch open the two screw dispensing gates, characterized in that: a second elastic device is disposed between the base and the delivery mechanism to form an elastic spacing between the base and the delivery mechanism.

2. The dispensed screw positioning unit as claimed in claim 1, wherein the second elastic device includes a threaded tube extending along the horizontal axis, a screw rod extending through the base and in threading connection with the threaded tube, and a spring mounted around the screw rod and disposed between the base and the delivery mechanism.

3. The dispensed screw positioning unit as claimed in claim 1, wherein the screw rod includes an outer end having a chamfered section configured to be clamped by a wrench.
